(19) United States
(12) Patent Application Publication
(10) Pub. No.: US 2008/0142589 A1
(43) Pub. Date: Jun. 19, 2008

(54) One Touch Purchase Device and System

(76) Inventor: Scott A. Cummings, Charlotte, VT (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/610,102

(22) Filed: Dec. 13, 2006

(51) Int. Cl. G06K 7/00

(52) U.S. Cl. 235/383

(57) ABSTRACT

A purchase transaction device is attached to each product to be purchased in a retail environment. The purchase transaction device is equipped with Electronic Article Surveillance (ESA), a biometric (thumbprint) or non-biometric reader, and the ability to transmit and receive information from a network. The purchase transaction device is also configured with a releasable locking mechanism attaching the device to the product.

### BACKGROUND

1. Field of the Invention

The embodiments of the invention generally relate to checkout devices and more particularly to a biometric checkout device adapted to be located within a physical store maintaining an inventory of items to be purchased.

2. Description of the Related Art

The internet has made online purchases quick and easy. Stored billing information can allow the purchase of an item with a single click. Brick and mortar stores have lagged behind in ease of purchases. Current self-checkout systems are extremely burdensome and, in some instances, do not save any time at all. There are several recent patents and patent applications that attempt to address this. One of the more advanced solutions is to enable the use of a shopper's wireless device to view product information and confirm purchase of the items. This solution is an improvement over current checkout methods, but still falls short of the goals of ‘pervasive’ computing. Solutions to this problem should include a secure transaction process for the shopper, with theft prevention measures for the retailer, that allow the shopper to make selections with a nearly invisible transaction process.

### SUMMARY

The invention comprises a device, system, and method that enables ‘one touch’ purchase of items in a brick and mortar store. With the inventive system items in the store are equipped with a biometric reader (thumbprint device) that is also a security device. The security device is similar in size and appearance to current antitheft devices attached to clothing.

When activated by the shopper, the biometric reader sends the user's unique signal to a network where the biometric signal is associated with shopper billing information. A purchase transaction is processed and an approved return signal disables or unlocks the security device completing the transaction. If an article is brought to the exit of the store with the device still attached or enabled, an alarm sounds.

More specifically, embodiments herein include a checkout system adapted to be located within a physical store maintaining an inventory of items (articles, goods, etc.) to be purchased. The checkout system has a central processor that is operatively connected to either a local or remote database and a sensing device operatively connected to the central processor. A purchase transaction device (e.g., transponder, security device, etc.) is physically connected to each different item in the store to be purchased. Further, the purchase transaction device is adapted to communicate with the sensing device (wirelessly, or by being temporarily connected to the sensing device). The system also includes an electronic article deactivation device operatively connected to the central processor.

One feature of the present embodiments is that the purchase transaction device comprises a shopper identification device (which can be biometric e.g., fingerprint reader, retinal reader, etc. or simply a shopper transponder, smartcard, etc.). In any case the shopper identification device is adapted to be handled and touched by a shopper while purchasing the item to be purchased.

The electronic article deactivation device is adapted to deactivate the security feature of the purchase transaction device while the shopper is purchasing the item to be purchased. Further, the central processor is adapted to complete a purchase transaction by using communications between the purchase transaction device and the sensing device to identify the item to be purchased and using only the shopper identification device to identify the shopper and acquire payment from the shopper (or acquire payment on behalf of the shopper).

The database maintains customer identification information such as biometric data adapted to identify the customer and payment data associated with the customer. The purchase transaction device is adapted to be physically removed from the item to be purchased after the item to be purchased has been purchased by the shopper. Further, the central processor can cause the electronic article deactivation device to deactivate the electronic article surveillance device after payment for the item being purchased has been acquired.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a schematic diagram of a checkout system according to embodiments herein; and

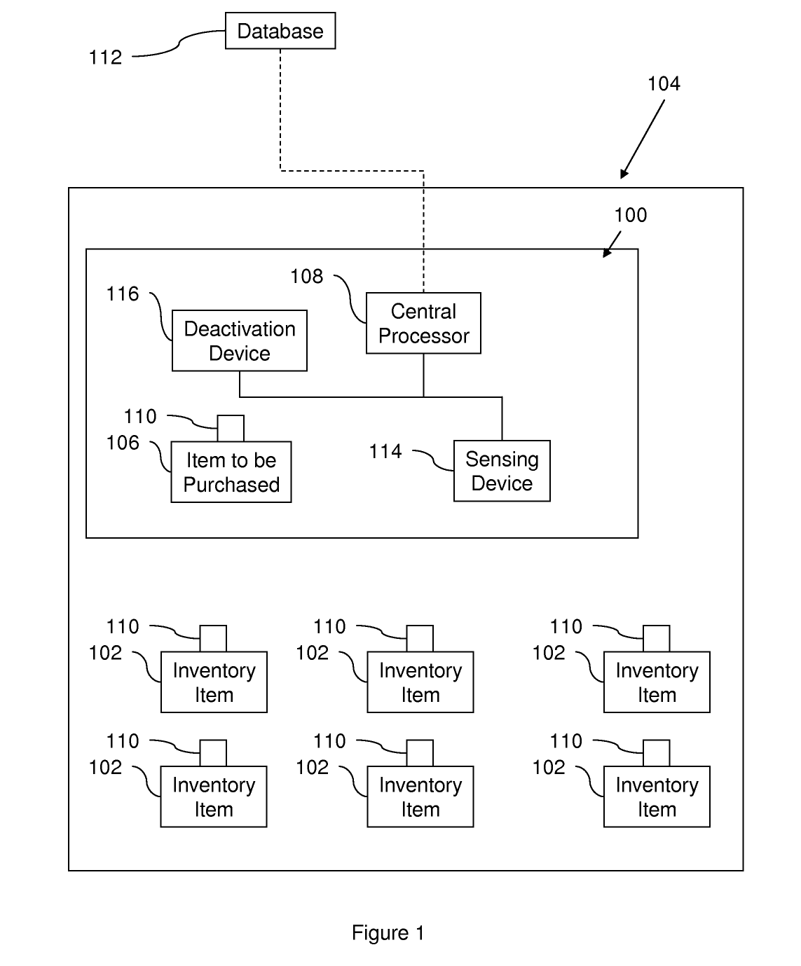

FIG. 2 is a schematic diagram of a purchase transaction device according to embodiments herein.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

In a retail environment, one of the inventive devices (which is sometimes referred to herein as a “purchase transaction device”) can be attached to each product. The inventive purchase transaction device is equipped with Electronic Article Surveillance (ESA), a biometric (thumbprint) or non-biometric reader, and the ability to transmit and receive information from a network. The purchase transaction device is also configured with a releasable locking mechanism attaching the device to the product.

Shopper profile information is stored in an in-store network or in a secure system accessible to an in store network (such as a bank). Shopper profile information includes at least biometric information and billing information.

Shoppers may examine or try on a product without removing the purchase transaction device. When a shopper wishes to purchase the product, the shopper places his or her thumb on the purchase transaction device if, for example, the purchase transaction device includes a fingerprint reader. The purchase transaction device reads the thumbprint, digitizes and encodes the thumbprint information, and transmits the coded information to the network. Billing information is accessed and the shopper's account is charged for the item. A confirmation signal is sent back to the purchase transaction device, which releases from the product.

Confirmation of the sale can be sent to a user's phone, PDA, email, or displayed on a screen in store accessible by the customer. In an alternate embodiment, the on-product biometric device can identify the item as being selected for purchase by the uniquely identified shopper to be followed by a self-checkout process. In the various embodiments, the purchase transaction device can stay on the product and the ESA can just be deactivated . . . especially if the product is a ‘smart’ product, such as clothing with smart fabric (circuitry built into fabric).

Other features of embodiments herein include that the store can be equipped with authorized only access for added security. Store attendants can release the device and conduct more traditional transaction for unregistered shoppers. The biometric information may not be stored in any part of the store network; rather, the transaction can be conducted by transmission to a third party repository of billing and biometric information, such as a bank and the store receives a transaction confirmation similar to a credit card sale. This confirmation triggers the disabling or release of the security device from the product.

More specifically, embodiments herein include a checkout system 100 adapted to be located within a physical store 104 maintaining an inventory of items (articles, goods, etc.) 102. One of the inventory items 102 that is to be purchased is shown as item 106 and is placed within the range of the checkout system 100 within the store 104.

The checkout system 100 has a central processor 108 that is operatively connected to either a local or remote database 112 and is operatively connected to a sensing device 114. The checkout system 100 comprises any part of the store 104 that is within the range of the sensing device 114, and can comprise the entire store 104. The central processor 108 and database 112 can comprise any form of processor and any form of database, whether currently known or developed in the future, and can be connected in a wired or wireless manner. For example, commonly available computers/database software is available from IBM Corporation, Armonk, N.Y., USA. Similarly, the sensing device 114 can comprise any wired or wireless device such as those disclosed in U.S. Pat. No. 6,507,279 and U.S. Publication 2005/0109838, which are incorporated herein by reference. Because the features, manufacturing techniques, etc. of such elements are well-known and readily available, they are not discussed in detail herein.

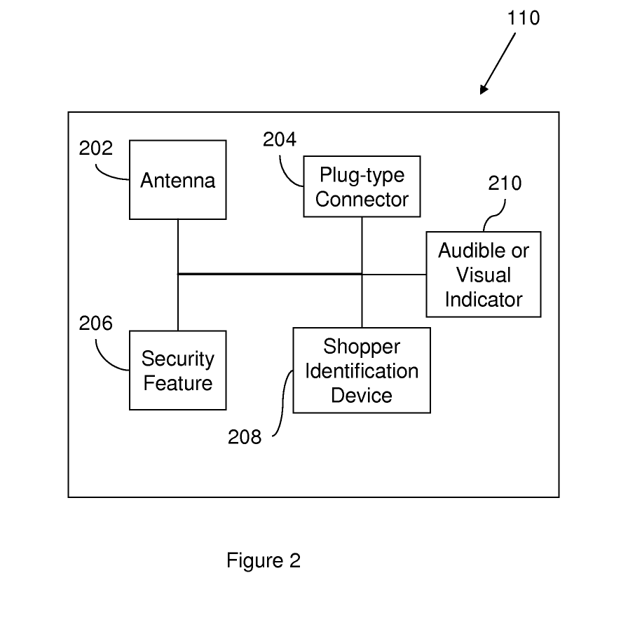

A purchase transaction device 110 (e.g., transponder, security device, etc.) can be physically connected to each different item in the store that is to be purchased with the inventive system. The purchase transaction device 110 is shown in greater detail in FIG. 2 and is adapted to communicate with the sensing device 114 (wirelessly, or by being temporarily connected to (plugged into) the sensing device 114). More specifically, the purchase transaction device includes an antenna 202 (having, for example, a power supply) and/or plug-type connector 204 to allow such wireless or temporary wired connections.

Further, the purchase transaction device 110 includes a security feature 206 used to prevent theft, such as Electronic Article Surveillance (ESA). The security feature 206 can comprise any commonly known security feature, such as those discussed in the above referenced U.S. Pat. No. 6,507,279 and U.S. Publication 2005/0109838. The system 100 also includes an electronic article deactivation device 116 operatively connected to the central processor 108, which is adapted to activate/deactivate the security feature 206. The sensing device 114 can be combined with the deactivation device 116 and many of these can be located throughout the store 104. Again, because the features, manufacturing techniques, etc. of such elements are well-known and readily available, they are not discussed in detail herein.

One feature of the purchase transaction device is that the purchase transaction device includes a shopper identification device 208. This shopper identification device 208 can comprise a biometric device such as a fingerprint reader, retinal reader, other reader of human body features, etc. Alternatively, the shopper identification device 208 can comprise a non-biometric device such as a transponder, smartcard, cell-phone, PDA, etc. that is carried by the shopper. Biometric devices are well-known and are disclosed, for example in U.S. Pat. No. 6,522,772 and U.S. Publication 2003/0150911, which are incorporated herein by reference. Once again, because the features, manufacturing techniques, etc. of such elements are well-known and readily available, they are not discussed in detail herein. In any case, the shopper identification device 208 is adapted to be handled and/or touched by a shopper while purchasing the item to be purchased 106.

Further, the central processor 108 can cause the electronic article deactivation device 116 to deactivate the electronic article surveillance device after payment for the item being purchased has been acquired. More specifically, the electronic article deactivation device 116 is adapted to deactivate the security feature 206 of the purchase transaction device 110 while the shopper is purchasing the item to be purchased 106 by sending a wired or wireless signal to the security feature 206 after payment for the item to be purchased 106 has been made by the central processor 108. The purchase transaction device 110 can also include a visual or audible indicator 210 to indicate to the shopper that the item has been paid for and can safely be removed from the store.

The purchase transaction device 110 can be adapted to be physically removed from the item to be purchased 106 after the item to be purchased 106 has been purchased by the shopper. Thus, the security feature 206 can comprise mechanical parts that allow it to be easily removed once the security feature 206 has been disabled so that the shopper can leave the purchase transaction device 110 in the store 104. However, this is not necessary and the purchase transaction device 110 can remain on the purchased item permanently.

The central processor 108 is adapted to complete a purchase transaction by using communications between the purchase transaction device 110 and the sensing device 114 to identify the item to be purchased 106. More specifically, using the coded signal received from the item to be purchased 106, the central processor 108 accesses the database 112 to identify the item to be purchased 106 and to determine its price. Further, the central processor 108 uses only the shopper identification device to identify the shopper and acquire payment from the shopper (or acquire payment on behalf of the shopper). In order to facilitate the foregoing, the database 112 maintains customer identification information such as biometric data adapted to identify the customer and payment data associated with the customer. A bank can hold both the biometric information and the billing information. All the store does is receive the biometric information and respond with a credit to the store.

Thus, with a single input (fingerprint swipe, retinal scan, PDA input, transponder wave, etc.) the shopper provides a coded input to the purchase transaction device 110 that the central processor 108 uses to retrieve shopper information (including pre-established payment information) from the database 112. Once payment is executed by the central processor 108 (based on the pre-established payment information within the database 112) the security feature 206 is deactivated by the deactivation device 116 and the customer can walk out of the store with the purchased item based on that single input. In other words, the customer can fully complete a purchase transaction simply by providing a single input directly to the purchase transaction device 110 that is directly attached to the item to be purchased 106, without providing any other input or taking any other action.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

1. A checkout system adapted to be located within a physical store maintaining an inventory of items to be purchased, said checkout system comprising:
a central processor operatively connected to a local database and or a remote database;
a sensing device operatively connected to said central processor;
a purchase transaction device physically connected to an item to be purchased, wherein said purchase transaction device is adapted to communicate with said sensing device; and
an electronic article deactivation device operatively connected to said central processor,
wherein said purchase transaction device comprises a shopper identification device adapted to be handled by a shopper, to identify said shopper, and to acquire payment from said shopper while purchasing said item to be purchased, and
wherein said electronic article deactivation device is adapted to deactivate a security feature of said purchase transaction device, while said shopper is purchasing said item to be purchased.

2. The device according to claim 1, wherein said database maintains customer identification information, and wherein said customer identification information comprises data adapted to identify said customer and payment data associated with said customer.

3. The device according to claim 1, wherein said purchase transaction device is adapted to be physically removed from said item to be purchased after said item to be purchased has been purchased by said shopper.

4. A checkout system adapted to be located within a physical store maintaining an inventory of items to be purchased, said checkout system comprising: a central processor operatively connected to a local database and or a remote database;
a sensing device operatively connected to said central processor;
a purchase transaction device physically connected to an item to be purchased, wherein said purchase transaction device is adapted to communicate with said sensing device; and
an electronic article deactivation device operatively connected to said central processor,
wherein said purchase transaction device comprises a biometric shopper identification device adapted to be touched by a shopper, to identify said shopper, and to acquire payment from said shopper while purchasing said item to be purchased,
wherein said electronic article deactivation device is adapted to deactivate a security feature of said purchase transaction device, while said shopper is purchasing said item to be purchased, and
wherein said central processor is adapted to complete a purchase transaction by:
using communications between said purchase transaction device and said sensing device to identify said item to be purchased;
using a single touch of said biometric shopper identification device to identify said shopper and acquire payment from said shopper; and
causing said electronic article deactivation device to deactivate said security feature after payment for said item being purchased has been acquired.

5. The device according to claim 4, wherein said database maintains customer identification information, and wherein said customer identification information comprises biometric data adapted to identify said customer and payment data associated with said customer.

6. The device according to claim 4, wherein said purchase transaction device is adapted to be physically removed from said item to be purchased after said item to be purchased has been purchased by said shopper.
